(19) United States
(12) Patent Application Publication
(10) Pub. No.: US 2023/0363492 A1
(43) Pub. Date: Nov. 16, 2023

(54) SHOE MIDSOLE

(71) Applicant: COOPER-STANDARD AUTOMOTIVE, INC., Northville, MI (US)

(72) Inventors: Krishnamachari GOPALAN, Troy, MI (US); Vahid SHAAYEGAN, Farmington Hills, MI (US)

(73) Assignee: COOPER-STANDARD AUTOMOTIVE, INC., Northville, MI (US)

(21) Appl. No.: 18/028,852

(22) PCT Filed: Sep. 28, 2021
(86) PCT No.: PCT/US2021/052414

§ 371 Date: Mar. 28, 2023

Related U.S. Application Data
(60) Provisional application No. 63/084,256, filed on Sep. 28, 2020.

(51) Int. Cl. A43B 13/12; A43B 13/04; C08L 23/26; C08J 9/10; C08J 9/00

(52) U.S. Cl. CPC A43B 13/125; A43B 13/04; C08J 9/0061; C08J 9/103; C08L 23/26; C08J 2203/04; C08J 2323/26; C08J 2423/08; C08J 2423/26; C08J 2431/04; C08L 2203/14; C08L 2205/025; C08L 2205/035; C08L 2310/00; C08L 2312/00

(57) ABSTRACT

A shoe midsole composed of a foamed peroxide-crosslinked polyolefin elastomer includes a silane-grafted polyolefin component and an elastomer component. The elastomer component includes ethylene vinyl acetate copolymer and a component selected from the group consisting of polyolefin elastomers, anhydride modified ethylene copolymers, and combinations thereof. The silane-grafted polyolefin component is crosslinked to the elastomer component with C-C bonds. The foamed peroxide-crosslinked polyolefin elastomer includes a plurality of closed cells. Characteristically, the foamed peroxide-crosslinked polyolefin elastomer is substantially free of silane crosslinking as formed and substantially free of water.

### CROSS REFERENCE TO RELATED APPLICATIONS

This application claims the benefit of U.S. Provisional Application Serial No. 63/084,256 filed Sep. 28, 2020, the disclosure of which is hereby incorporated in its entirety by reference herein.

### TECHNICAL FIELD

In at least one aspect, the present invention is related to polymer compositions that may be used to form shoe midsoles.

### BACKGROUND

Materials used to form shoe midsoles need to satisfy a variety of material property requirements. In particular, properties such as density, rebound, wear) resistance, stiffness measured as hardness, processability, and/or shock absorbance are important parameters. From the shoes of athletes to the elderly, the shoe’s sole must provide superior comfort, traction, and durability. Improvements in the material property requirements for shoe midsoles often involve the development of new polymer compositions and methods of making soles that are multifunctional. Moreover, it is desirable that shoe midsoles are simpler to produce, lighter in weight, and have superior durability over a longer period of time.

The most common materials used in the manufacture of midsoles are the expanded foam rubber version forms of ethylene vinyl acetate (EVA). Like most rubbers, EVA is soft and flexible, but it is also easy to process and manipulate in the manufacturing of versatile articles (midsoles included) due to its thermoplastic properties (before it is crosslinked). While EVA is typically selected as the desired material to produce midsoles because of its “low-temperature” toughness, stress-crack resistance, waterproof properties, and resistance to UV-radiation, the biggest critique against EVA is its short life. Over time, EVA tends to compress and users (runners especially) say that they feel their shoes go flat after a period of time. Currently, the only way to avoid this flattening of the EVA midsole is to replace one’s shoes every 3 to 6 months.

Accordingly, there is a need for improved compositions for forming shoe midsoles.

### SUMMARY

In at least one aspect, a shoe midsole composed of a foamed peroxide-crosslinked polyolefin elastomer is provided. The foamed peroxide-crosslinked polyolefin elastomer includes a silane-grafted polyolefin component and an elastomer component. The elastomer component includes ethylene vinyl acetate copolymer and a component selected from the group consisting of polyolefin elastomers, anhydride modified ethylene copolymers, and combinations thereof. The silane-grafted polyolefin component and elastomer component being crosslinked with C-C bonds. Advantageously, the foamed peroxide-crosslinked polyolefin elastomer includes a plurality of closed cells. Characteristically, the foamed peroxide-crosslinked polyolefin elastomer is substantially free of silane crosslinking as formed and substantially free of water.

In another aspect, a method for preparing a shoe midsole is includes steps of forming a component A that includes a mixture of a first silane-grafted polyolefin and a second silane-grafted polyolefin. The method also includes a step of forming a masterbatch (i.e., component B) that includes a blowing agent, a peroxide, and an elastomer component that includes ethylene vinyl acetate copolymer and a polymer selected from the group consisting of polyolefin elastomers, anhydride modified ethylene copolymers, and combinations thereof. Component A and the masterbatch (i.e., component B) are mixed together to form a reactive mixture. The reactive mixture is reacted for a predetermined time period under moisture-free conditions at a reaction temperature to form a foamed peroxide-crosslinked polyolefin elastomer such that the first silane-grafted polyolefin is crosslinked to the second silane-grafted polyolefin and to the elastomer component with C-C bonds and the second silane-grafted polyolefin is crosslinked to the elastomer component with C-C bonds and such that the foamed peroxide-crosslinked polyolefin elastomer includes a plurality of closed cells. Characteristically, the foamed peroxide-crosslinked polyolefin elastomer is substantially free of silane crosslinking as formed and substantially free of water.

In another aspect, a masterbatch for forming a midsole is provided. The masterbatch includes a blowing agent, a peroxide, additives and an elastomeric component. The elastomeric component includes one or more elastomers selected from the group consisting of ethylene vinyl acetate copolymers, polyolefin elastomers, anhydride-modified ethylene copolymers, and combinations thereof. The masterbatch is adapted to be combined (e.g., mixed) with a Component A under moisture-free conditions to form a reactive mixture. The Component A including a mixture of a first silane-grafted polyolefin and a second silane-grafted polyolefin and optionally one or more additional silane-grafted polyolefins. Characteristically, the reactive mixture is reacted for a predetermined time period under moisture-free conditions at a reaction temperature to form a foamed peroxide-crosslinked polyolefin elastomer such that the first silane-grafted polyolefin is crosslinked to the second silane-grafted polyolefin and to the elastomer component with C-C bonds and the second silane-grafted polyolefin is crosslinked to the elastomer component with C-C bonds and such that the foamed peroxide-crosslinked polyolefin elastomer includes a plurality of closed cells. The foamed peroxide-crosslinked polyolefin elastomer is substantially free of silane crosslinking as formed and substantially free of water.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIG. 1. A perspective view of a shoe according to some aspects of the present disclosure.

FIG. 2. A cross-sectional perspective view of the shoe depicted in FIG. 1.

FIG. 3A. Perspective view of a shoe midsole.

FIG. 3B. A cross-sectional view of a shoe midsole.

FIG. 3C. A flowchart depicting the method of making a shoe midsole.

FIG. 4. Plots from a shear rheometer using a rotational cylinder comparing a POE with silane grafting and without silane grafting.

FIGS. 5A and 5B. Stress versus strain for example 1 and EVA control example.

FIG. 6. DSC plots of heat flow versus temperature for example 1 and EVA control example.

FIG. 7. Heating section for the DSC plots of heat flow versus temperature for example 1 and EVA control example.

FIG. 8A. Plots of Tan δ versus temperature for examples example 1 and EVA control example.

FIG. 8B. Plots of storage modulus versus temperature for example 1 and EVA control example.

FIG. 9. Cure curve plots for example 1 and EVA control example.

FIG. 10. Plots of shear stress versus shear rate obtained from a Rubber Process Analyzer (RPA) that are used to determine long chain branching.

FIGS. 11A and 11B. SEM cross-section for Example 1 at 25X (A) and 50x (B).

FIGS. 12A and 12B. SEM cross-section for EVA control example at 25X (A) and 50x (B).

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: all R groups (e.g. Rᵢ where i is an integer) include hydrogen, alkyl, lower alkyl, C₁₋₆ alkyl, C₆₋₁₀ aryl, C₆₋₁₀ heteroaryl, —NO₂, —NH₂, —N(R′R″), —N(R′R″R″’)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, -COO⁻M⁺, —CF₂H, —CF₂R′, —CFH₂, and —CFR′R″ where R′, R″ and R‴ are C₁₋₁₀ alkyl or C₆₋₁₈ aryl groups, M⁺ is a metal ion, and L⁻ is a negatively charged counter ion; single letters (e.g., “n” or “o”) are 1, 2, 3, 4, or 5; in the compounds disclosed herein a CH bond can be substituted with alkyl, lower alkyl, C₁₋₆ alkyl, C₆₋₁₀ aryl, C₆₋₁₀ heteroaryl, —NO₂, —NH₂, —N(R′R″), —N(R′R″R″’)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻ M⁺, —CF₂H, —CF₂R′, -CFH₂, and -CFR′R” where R′, R” and R”′ are C₁₋₁₀ alkyl or C₆₋₁₈ aryl groups, M⁺ is a metal ion, and L⁻ is a negatively charged counter ion; percent, “parts of,” and ratio values are by weight; the term “polymer” includes “oligomer,” “copolymer,” “terpolymer,” “block”, “random,” “segmented block,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” “block”, “random,” “segmented block,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/- 5% of the value. As one example, the phrase “about 100” denotes a range of 100+/- 5, i.e. the range from 95 to 105. Generally, when the term “about” is used, it can be expected that similar results or effects according to the invention can be obtained within a range of +/- 5% of the indicated value.

As used herein, the term “and/or” means that either all or only one of the elements of said group may be present. For example, “A and/or B” shall mean “only A, or only B, or both A and B.” In the case of “only A,” the term also covers the possibility that B is absent, i.e., “only A, but not B.”

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “comprising” or “including.” Typically, this phrase is used to denote that an object is formed from a material.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” as a subset.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ± 0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4. . . .97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

In the examples set forth herein, properties, concentrations, temperature, and reaction conditions (e.g., pressure, pH, flow rates, etc.) can be practiced within plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

For all compounds expressed as an empirical chemical formula with a plurality of letters and numeric subscripts (e.g., CH₂O), values of the subscripts can be plus or minus 50 percent of the values indicated rounded to or truncated to two significant figures. For example, if CH₂O is indicated, a compound of formula C_{(0.8-1.2)}H_{(1.6-2.4)}O_{(0.8-1.2)}. In a refinement, values of the subscripts can be plus or minus 30 percent of the values indicated rounded to or truncated to two significant figures. In still another refinement, values of the subscripts can be plus or minus 20 percent of the values indicated rounded to or truncated to two significant figures.

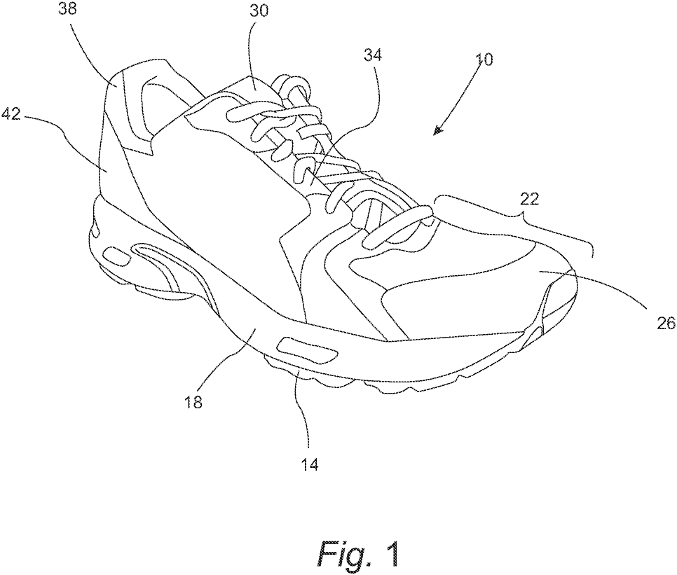

For purposes of description herein the terms “upper,” “lower,” “right,” “left,” “rear,” “front,” “vertical,” “horizontal,” and derivatives thereof shall relate to the shoe soles of the disclosure as oriented in the shoe shown in FIG. 1. However, it is to be understood that the shoe soles, compositions and methods may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The term “copolymer” refers to a polymer, which is made by linking more than one type of monomer in the same polymer chain.

The term “comonomer” refers to olefin comonomers which are suitable for being polymerized with olefin monomers, such as ethylene or propylene monomers.

The term “homopolymer” refers to a polymer which is made by linking olefin monomers, in the absence of comonomers.

The term “polymer backbone” means a covalent chain of repeating monomer units that form the polymer to which a pendant group including another polymer backbone is optionally attached.

The term “residue”, means a portion, and typically a major portion, of a molecular entity, such as molecule or a part of a molecule such as a group, which has underwent a chemical reaction and is now covalently linked to another molecular entity. In a refinement, the term “residue” means and organic structure that is incorporated into the polymer by a polycondensation or ring-opening polymerization reaction involving the corresponding monomer. In another refinement, the term “residue” when used in reference to a monomer or monomer unit means the remainder of the monomer unit after the monomer unit has been incorporated into the polymer chain.

Abbreviations:

“C/set” means compression set.

“DSC” means Differential Scanning Calorimetry.

“Eb” means elongation at break.

“EPDM” means ethylene propylene diene monomer.

“ER” means expansion ratio.

“EVA” means ethylene vinyl acetate.

“Hd” means hardness.

“Mn” means number averaged molecular weight.

“Mw” means is the weight averaged molecular weight.

“phr” means parts per 100 parts by weight of rubber.

“POE” means a polyolefin elastomer.

“Sp. Gr.” means specific gravity.

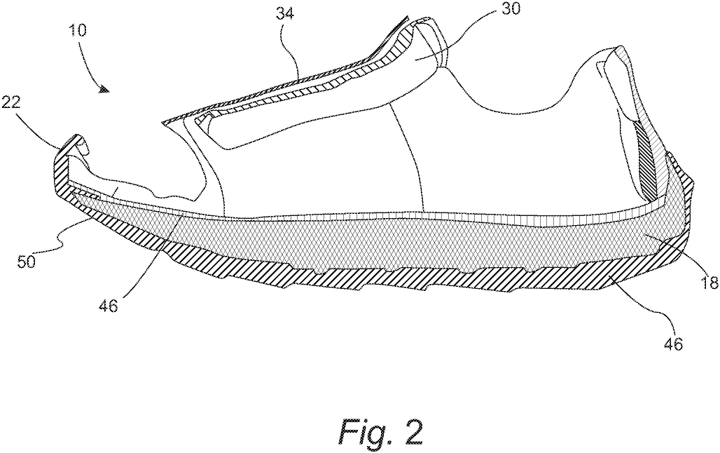

FIG. 1 provides a perspective view of a shoe that includes the midsole composed of a foamed peroxide-crosslinked polyolefin elastomer set forth herein. FIG. 2 provides a cross-sectional view of the shoe depicted in FIG. 1. Shoe 10 includes an outsole 14 coupled to a midsole 18 where the midsole 18 is positioned directly above the outsole 14. A toe box 22 makes up a front portion of the shoe 10 in combination with a toe cap 26. The toe box 22 and toe cap 26 are positioned to support and enclose toes of a foot. A tongue 30 works in combination with uppers 34 to support the top of the foot. A collar 38 and a heal counter 42 are positioned at a rear of the shoe 10 and work together to comfortably position and retain a heel in the shoe 10. Although the footwear depicted in FIG. 1 is a running shoe, the shoe 10 is not meant to be limiting and the shoe 10 could additionally include, for example, other athletic shoes, sandals, hiking boots, winter boots, dress shoes, and medical orthotic shoes. The cross-sectional view of FIG. 2 provides the respective thickness of the outsole 14 compared to the midsole 18. The midsole 18 is the part of the shoe 10 that is sandwiched between the outsole 14 and an instep liner 46. Midsole 18 provides cushioning and rebound, while helping protect the foot from feeling hard or sharp objects. The foot is in contact with a sock liner 50 that is positioned as a top layer on the instep liner 46 while the foot’s positioning in the interior of the shoe 10 is maintained with the toe box 22, tongue 30, and uppers 34.

In at least one aspect, the foamed peroxide-crosslinked polyolefin elastomer includes a silane-grafted polyolefin component (e.g., residues derived from Component A described below) and an elastomer component (e.g., residues derived from Component B described below). In a refinement, the elastomer component includes an ethylene vinyl acetate copolymer and a component selected from the group consisting of polyolefin elastomers, anhydride modified ethylene copolymers, and combinations thereof. The silane-grafted polyolefin component is crosslinked to the to the elastomer component with C-C bonds. The foamed peroxide-crosslinked polyolefin elastomer includes a plurality of closed cells that can assist in moisture resistance. In particular, the plurality of closed cells includes a connected network of closed cells. Characteristically, the foamed peroxide-crosslinked polyolefin elastomer is substantially free of silane crosslinking as formed and substantially free of water. In a refinement, the initially formed foamed peroxide-crosslinked polyolefin elastomer has a water content that is less than about 0.10 weight percent (of the foamed peroxide-crosslinked polyolefin elastomer), in particular less than or equal to about 0.05 weight percent. Advantageously, the foamed peroxide-crosslinked polyolefin elastomer and/or the shoe midsole is substantially free of a condensation catalyst or a residue thereof.

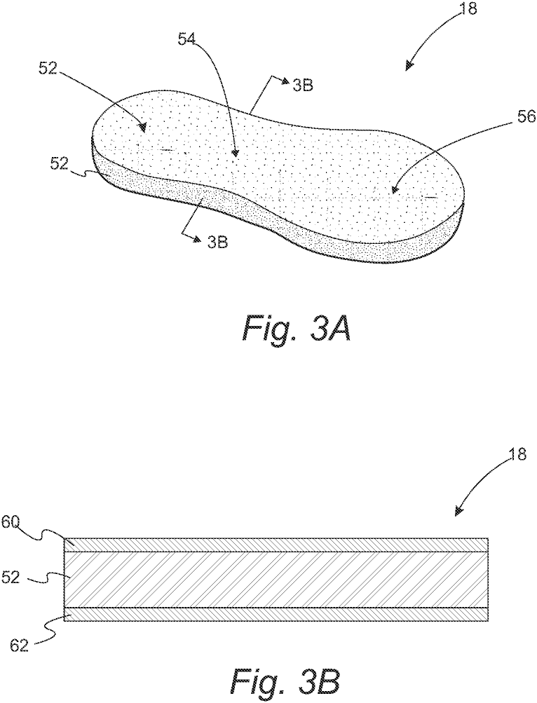

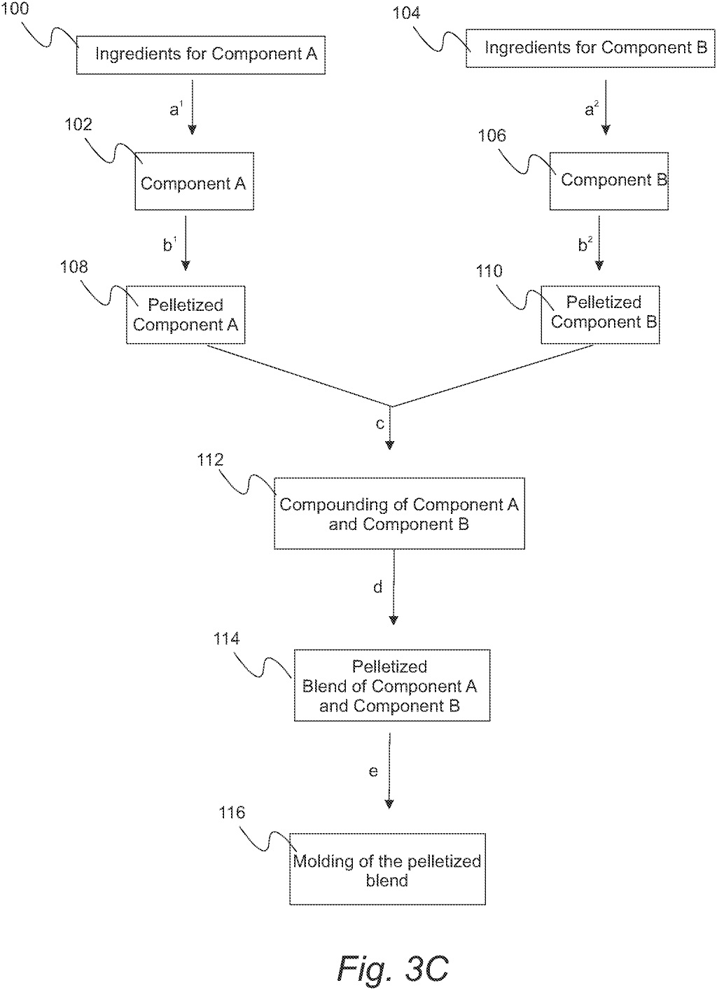

Referring to FIGS. 3A and 3B, midsole 18 and foamed peroxide-crosslinked polyolefin elastomer 52 has a shape configured to be placed in a shoe above an outsole. Midsole 18 has an elongated shape with a first section 54 that is configured to contact the hindfoot of a person’s foot, a second section 56 that is configured to contact the middle foot of a person’s foot, and a third section 58 that is configured to contact the forefoot of a person’s foot. Therefore, an outer contour 60 of midsole 18 has sufficient dimensions to completely surround a human foot. Typically, the third section 58 is wider than the second section 56 and/or the first section 54. Midsole 18 can optionally include one or both of skin layers 60 and 62. In a refinement, the skin layers 60 and 62, when present, have a thickness from about 0.5 microns to about 10 microns. Midsoles provide stability for the foot. The midsole set forth herein can endure all types of challenges typical of footwear, i.e., terrain, the user’s weight, pressure sources incurred during walking or running, and the like.

In some aspects, the foamed peroxide-crosslinked polyolefin elastomer and/or the shoe midsole includes from about 100 closed cells/mm³ to 1×10⁵ closed cells/mm³. In some refinements, the foamed peroxide-crosslinked polyolefin elastomer and/or the shoe midsole includes at least, in increasing order of preference, 50 closed cells/mm³, 100 closed cells/mm³, 200 closed cells/mm³, 300 closed cells/mm³, or 400 closed cells/mm³. In a further refinement, the foamed peroxide-crosslinked polyolefin elastomer and/or the shoe midsole includes at most, in increasing order of preference 1×10⁵ closed cells/mm³, 1×10⁴ closed cells/mm³, 1×10³ closed cells/mm³, or 500 closed cells/mm³. The SEM micrographs described below demonstrate that the closed cells form a connected network that can act as a barrier to water (i.e., moisture) penetrating into the foamed peroxide-crosslinked polyolefin elastomer. This is verified by the water absorption experiments set forth below show that the foamed peroxide-crosslinked polyolefin elastomer and/or the shoe midsole exhibit less than 0.15 % water absorption (e.g., ASTM D 1056).

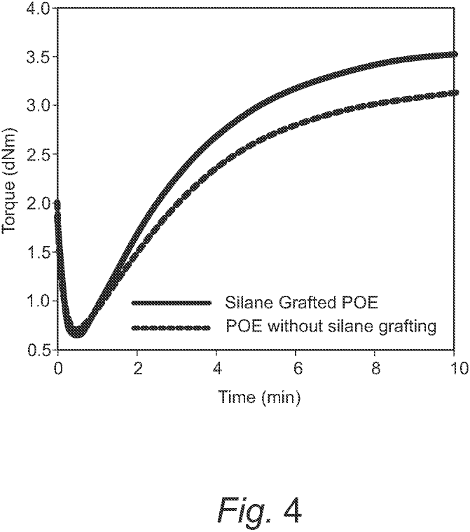

Advantageously, the foamed peroxide-crosslinked polyolefin elastomer and/or the shoe midsole exhibit increased resilience combined with decreased shrinkage compared to many prior art formulations. In particular, the foamed peroxide-crosslinked polyolefin elastomer and the shoe midsole each have a melting temperature (i.e., melting point) of crystalline regions that is greater than about 60° C. Melting temperatures of crystalline regions can be determined by DSC measurements, as set forth below. In a refinement, the foamed peroxide-crosslinked polyolefin elastomer and/or the shoe midsole each have a melting temperature of crystalline regions greater than, in increasing order of preference, 40° C., 50° C., 60° C., 65° C., 70° C., 75° C., or 80° C. Typically, the melting temperature of crystalline regions of the foamed peroxide-crosslinked polyolefin elastomer and/or the shoe midsole is less than in increasing order of preference, 70° C., 80° C., 90° C., 100° C., 110° C., 120° C., or 130° C. The melting temperature of crystalline regions is a significant parameter in controlling shrinkage of the foamed peroxide-crosslinked polyolefin elastomer and/or the shoe midsole. When the foamed peroxide-crosslinked polyolefin elastomer and/or the shoe midsole is not subjected to a temperature at or above the melting temperature of crystalline regions, the crystals don’t melt, thereby keeping the part together such that there is low shrinkage. Shrinkage is an important factor in assembly processes, storage, and in maintaining dimension stability of parts that are stored and transported. In addition to reduced shrinkage, the foamed peroxide-crosslinked polyolefin elastomer and/or the shoe midsole also exhibit improved resilience. FIG. 4 provides plots from a shear rheometer using a rotational cylinder comparing a POE with silane grafting and without silane grafting. The silane grafted POE is observed to give higher torque indicating on a higher crosslink density which in turn indicates on a higher resilience. Therefore, silane grafted polymers are chosen to managing resilience..

In a variation, the silane-grafted polyolefin component includes one or more silane-grafted polyolefin components. Silane grafting is facilitated by combining a silane mixture combined with one or more polyolefins. In a refinement, the one or more silane-grafted polyolefin components independently include silane functional groups grafted onto one or more polyolefins. Suitable silane functional groups are described by formula I:

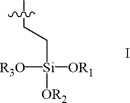

wherein R₁, R₂, and R₃ are each independently H or C₁₋₈ alkyl. In a refinement, R₁, R₂, and R₃ are each independently methyl, ethyl, propyl, or butyl. Typically, the silane-grafted polyolefin component is formed from the requisite polyolefins prior to combining with the masterbatch (Component B) as set forth below in more detail.

In one refinement, the silane-grafted polyolefin component includes a first silane-grafted polyolefin and a second silane-grafted polyolefin and optionally one or more additional silane grafted polyolefins. In a refinement, the first silane-grafted polyolefin and the second silane-grafted polyolefin each independent includes internal C-C crosslinking. In a further refinement, the first silane-grafted polyolefin is crosslinked to the second silane-grafted polyolefin and to the elastomer component with C-C bonds. In a still a further refinement, the second silane-grafted polyolefin is crosslinked to the elastomer component with C-C bonds. In a variation, the first silane-grafted polyolefin has a first melt index less than about 5 while the second silane-grafted polyolefin has a second melt index greater than about 20. In another aspect, the first silane-grafted polyolefin has a higher weight average molecular weight that the second silane-grafted polyolefin.

In a variation, the silane-grafted polyolefin component (e.g., the first silane-grafted polyolefin and the second silane-grafted polyolefin) is selected from the group consisting of silane-grafted ethyleneα-olefin copolymers, silane-grafted polyolefin elastomer (POE), silane-grafted olefin block copolymers, and combinations thereof. Each of these silane-grafted ethylene α-olefin copolymers, silane-grafted polyolefin elastomer (POE), silane-grafted olefin block copolymers may be formed using at least one base polyolefin n as set forth below in more detail.

In other refinements, the first silane-grafted polyolefin and/or the second silane-grafted polyolefin (and/or any additional silane-grafted polymers in component A) is selected from the group consisting of silane-grafted olefin homopolymers, blends of silane-grafted homopolymers, silane-grafted copolymers of two or more olefins, blends of silane-grafted copolymers of two or more olefins, and a combination of silane-grafted olefin homopolymers blended with silane-grafted copolymers of two or more olefins.

In still other refinements, the first silane-grafted polyolefin and the second silane-grafted polyolefin (and/or any additional silane-grafted polymers in component A) are each independently a silane-grafted homopolymer or silane-grafted copolymer of an olefin selected from the group consisting of ethylene, propylene, 1-butene, 1-propene, 1-hexene, 1-octene, C₉₋₁₆ olefins, and combinations thereof.

In another refinement, the first silane-grafted polyolefin and the second silane-grafted polyolefin (and/or any additional silane-grafted polymers in component A) independently include a polymer selected from the group consisting of silane-grafted block copolymers, silane-grafted ethylene propylene diene monomer polymers, silane-grafted ethylene octene copolymers, silane-grafted ethylene butene copolymers, silane-grafted ethylene α-olefin copolymers, silane-grafted 1-butene polymer with ethene, silane-grafted polypropylene homopolymers, silane-grafted methacrylate-butadiene-styrene polymers, silane-grafted polymers with isotactic propylene units with random ethylene distribution, silane-grafted styrenic block copolymers, silane-grafted styrene ethylene butylene styrene copolymer, and combinations thereof.

In another refinement, the first and/or second silane-grafted polyolefin is selected from the group consisting of silane-grafted olefin homopolymers, blends of silane-grafted homopolymers, silane-grafted copolymer of two or more olefins, blends of silane-grafted copolymers of two or more olefins, and blends of silane-grafted olefin homopolymers with silane-grafted copolymers of two or more olefins.

In still another refinement, the first and/or second silane-grafted polyolefin is a silane grafted homopolymer or copolymer of an olefin is selected from the group consisting of ethylene, propylene, 1-butene, 1-propene, 1-hexene, 1-octene, and C₉₋₁₆ olefins.

It should be appreciated that each of these examples for the first silane-grafted polyolefin and the second silane-grafted polyolefin are formed from base polyolefin or polymer not having the silane grafting.

In some aspects, the elastomer component includes ethylene vinyl acetate copolymer. Typically, the ethylene vinyl acetate copolymer has a vinyl acetate content from about 10 to 50 mole percent. In a refinement, the ethylene vinyl acetate copolymer has a vinyl acetate content of at least 5 mole percent, 10 mole percent, 15 mole percent, 20 mole percent, or 25 mole percent. In a further refinement, ethylene vinyl acetate copolymer has a vinyl acetate content of at most 60 mole percent, 50 mole percent, 40 mole percent, 35 mole percent, or 30 mole percent.

In some aspects, the elastomer component includes a copolymer of an olefin selected from the group consisting of ethylene, propylene, 1-butene, 1-propene, 1-hexene, 1-octene, C₉₋₁₆ olefins, and combinations thereof. In a refinement, the elastomer component includes a polymer selected from the group consisting of block copolymers, ethylene propylene diene monomer polymers, ethylene octene copolymers, ethylene butene copolymers, ethylene α-olefin copolymers, 1-butene polymer with ethene, polypropylene homopolymers, methacrylate-butadiene-styrene polymers, polymers with isotactic propylene units with random ethylene distribution, styrenic block copolymers, styrene ethylene butylene styrene copolymer, and combinations thereof. It should be appreciated that the elastomer component can also include any of the polymers listed for the base polyolefin set forth below.

In some aspects, the foamed peroxide-crosslinked polyolefin elastomer and/or the shoe midsole includes an additive selected from the group consisting of silicon rubber, zinc oxide, stearic acid, silane-modified amorphous poly-alpha-olefins, trans-polyoctenamer-rubber (TOR), silica/silicon oxide, titanium oxide, organic pigments, (e.g., red organic pigment, blue organic pigment), triallyl cyanurate, and combinations thereof. In a refinement, the additives includes activators, accelerators, and crosslinking agents. Zinc oxide is an example of an activator. Triallyl cyanurate can be characterized as a co-agent, crosslinking agent, accelerator, or an activator. In a refinement, stearic acid and/or zinc oxide is used to achieve the properties regarding the melting temperature, tear strength, and Shore C hardness. In a refinement, these additive are independently present in amounts with reference to the total weight of the foamed peroxide-crosslinked polyolefin elastomer and/or the shoe midsole as follow: silicon rubber in an amount from about 0.0 weight percent to 10.0 weight percent or in an amount from about 1 weight percent to 18.0 weight percent; zinc oxide in an amount from about 0 weight percent to 8 weight percent or in an amount from about 1 weight percent to 5.0 weight percent; stearic acid in an amount from about 0 weight percent to 8 weight percent or 1 weight percent to 2.0 weight percent; silane-modified amorphous poly-alpha-olefins in an amount from about 0.0 weight percent to 10.0 weight percent or in an amount from about 1 weight percent to 6.0 weight percent; trans-polyoctenamer-rubber (TOR) in an amount from about 0.0 weight percent to 6.0 weight percent or in an amount from about 1 weight percent to 4.0 weight percent; silica/ silicon oxide in an amount from about 0.0 weight percent to 18.0 weight percent or 1 weight percent to 12.0 weight percent; titanium oxide in an amount from about 0.0 to 12.0 weight percent or in an amount from about 1 weight percent to 10.0; organic pigments in an amount from about 0 to 2 weight percent or in an amount from about 0.01 weight percent to 1.5 weight percent, di(tert-butylperoxyisopropyl) benzene in an amount from about 0 weight percent to 5 weight percent or in an amount from about 0.5 weight percent to 3.0 weight percent; and triallyl cyanurate in an amount from about 0.01 weight percent to 0.3 weight percent or 0.05 weight percent to 0.2 weight percent. The foamed peroxide-crosslinked polyolefin elastomer and/or the shoe midsole can also include residues of a blowing agent (e.g., azodicarbonamide and modified azodicarbonamide), crosslinkers, addition promotors, and the like.

In a refinement, the first silane-grafted polyolefin has a density less than 0.86 g/cm3 and the second silane-grafted polyolefin has a crystallinity less than 40%.

In a refinement, the first silane-grafted polyolefin is present in an amount from about 60 to 80 weight percent of the total weight of the shoe midsole while the second silane-grafted polyolefin is present in an amount from about 20 to 40 weight percent of the total weight of the shoe midsole.

Typically, the foamed peroxide-crosslinked polyolefin elastomer and/or the shoe midsole has a rebound resilience of at least 60%. In some refinements, the foamed peroxide-crosslinked polyolefin elastomer and/or the shoe midsole has a rebound resilience of at least, in increasing order of preference, 10%, 20%, 30%, 40%, 50%, 60%, 70%, 80%, or 90%. It is noted that 100% is the highest attainable value for the rebound resilience.

Advantageously, the shoe midsole exhibits a compression set of from about 1.0% to about 80.0%, as measured after 6 hours being tested at 50° C. (50% compression). Advantageously, the shoe midsole exhibits a compression set of from about 1.0% to about 76.8%, as measured after 6 hours being tested at 50° C. (50% compression). In a refinement, the shoe midsole exhibits a compression set of from about 1.0% to about 67.0%, as measured after 6 hours being tested at 50° C. (50% compression).

In some aspects, the specific gravity of the foamed peroxide-crosslinked polyolefin elastomer or the shoe midsole is from about 0.1 to about 0.30 g/cm³. In a refinement, the specific gravity of the foamed peroxide-crosslinked polyolefin elastomer or the shoe midsole is at most in increasing order of preference, 0.60 g/cm³, 0.50 g/cm³, 0.40 g/cm³, 0.30 g/cm³, or 0.25 g/cm³. In a further refinement, the specific gravity of the foamed peroxide-crosslinked polyolefin elastomer or the shoe midsole is at least, in increasing order of preference, 0.05 g/cm³, 0.10 g/cm³, 0.12 g/cm³, 0.13 g/cm³, or 0.15 g/cm³. 0.20 g/cc.

In some aspects, the foamed peroxide-crosslinked polyolefin elastomer and/or the shoe midsole exhibit a glass transition temperature from about -75° C. to about -25° C. In a refinement, the foamed peroxide-crosslinked polyolefin elastomer and/or the shoe midsole exhibit a glass transition temperature of at least, in increasing order of preference, -75° C., -65° C., -60° C., -50° C., or -45° C. In a further refinement, the foamed peroxide-crosslinked polyolefin elastomer and/or the shoe midsole exhibit a glass transition temperature of at most, in increasing order of preference, -25° C., -30° C., -40° C., or -50° C. The glass transition temperature can be determined by differential scanning calorimetry (DSC) using a second heating run at a rate of 5° C./min or 10° C./min.

With reference to FIG. 3C, a method for preparing the foamed peroxide-crosslinked polyolefin elastomer and/or the shoe midsole set forth above is provided. The method includes a step a¹) in which ingredients (Box 100) are used to forming component A (Box 102) from the ingredients set forth herein (Box 100) that includes a mixture of a first silane-grafted polyolefin and a second silane-grafted polyolefin (and optionally, one or more additional silane-grafted polyolefins). The method also includes a step a²) in which ingredient (Box 104) are used to form a masterbatch (i.e., component B) (Box 106) that includes at least one elastomer (e.g., an elastomeric composition). Typically, masterbatch (i.e., component B) also includes a blowing agent and a peroxide. As set forth above, the elastomers are selected from the group consisting of ethylene vinyl acetate copolymers, polyolefin elastomers, anhydride-modified ethylene copolymers, and combinations thereof. In a refinement, Component A and Component B are independently pelletized in steps b¹) and b²), respectively as shown by Boxes 108 and 110. Component A and the masterbatch (i.e., component B) are mixed to form a reactive mixture in step c) as shown in Box 112. In a refinement, the reactive mixture is pelletized d) as shown in Box 114. In a variation, 50 to 90 weight percent of component A is mixed with 50 to 10 weight percent of component B. In a refinement, 60 to 80 weight percent of component A is mixed with 40 to 20 weight percent of component B. In still another refinement, 65 to 75 weight percent of component A is mixed with 35 to 25 weight percent of component B.

In step e) as shown by Box 116, the reactive mixture is reacted for a predetermined time period under moisture-free conditions at a reaction temperature to form a foamed peroxide-crosslinked polyolefin elastomer such that the first silane-grafted polyolefin is crosslinked to the second silane-grafted polyolefin and to the elastomer component with C-C bonds and the second silane-grafted polyolefin is crosslinked to the elastomer component with C-C bonds. In other words, the silane-grafted polyolefin component is crosslinked to the elastomer component with C-C bonds. The reactive mixture is also reacted such that the foamed peroxide-crosslinked polyolefin elastomer includes a plurality of closed cells. The silane-grafted component are residues of component A and the elastomer component are residues of component B as defined above. The predetermined time period and the reaction temperature will depend on the specific compositions for component A and the masterbatch (i.e., component B). Typically, the predetermined time period is from about 200 to 600 seconds, and the reaction temperature is from about 160 to 200° C. In some variations, the reactive mixture is reacted in the molding apparatus. In a refinement, the reactive mixture is reacted in an injection molding apparatus.

In some refinements, the method further includes a step of molding the foamed peroxide-crosslinked polyolefin elastomer into a shoe midsole. The molding can be performed by any suitable molding process including, but not limited to, compression molding, injection molding, injection compression molding, and supercritical injection molding. Details of the resultant foamed peroxide-crosslinked polyolefin elastomer or the plaques (representing the shoe midsole) are the same as set forth above.

In particular, as set forth above, the silane-grafted polyolefin component can include one or more silane-grafted polyolefin components. The silane-grafted polyolefin component is formed by silane grafting at least one base polyolefin. Silane grafting is achieved by combining a silane mixture combined with one or more polyolefins. The silane mixture may include one or more silanes, oils, peroxides, antioxidants, and/or other components such as a grafting initiator. The synthesis of the silane-grafted polyolefin component may be performed as described in the grafting steps outlined using the single-step Monosil process or the two-step Sioplas process as disclosed in U.S. Pat. Application Ser. No. 15/836,436, filed Dec. 8, 2017, entitled “Shoe Soles, Compositions, And Methods Of Making The Same” which is herein incorporated by reference in its entirety. In a refinement, the silane is a vinyl alkoxy silane having the following formula:

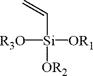

wherein R₁, R₂, and R₃ are each independently H or C₁₋₈ alkyl. Example silanes include, but are not limited to vinyl trimethoxy silanes, vinyl triethoxy silanes, and vinyl tripropoxy silanes. Therefore, the one or more silane-grafted polyolefin components independently include silane functional groups grafted thereon having formula I:

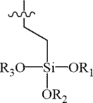

wherein R₁, R₂, and R₃ are each independently H or C₁₋₈ alkyl. In a refinement, R₁, R₂, and R₃ are each independently methyl, ethyl, propyl, or butyl. Typically, the silane-grafted polyolefin component is formed from the requisite polyolefins prior to combining prior to combining with the elastomer component as set forth below in more detail. When silane-grafted polyolefin component includes a plurality of silane-grafted polyolefins, a mixture of base polyolefins can be formed and then silane grafted. Alternatively, the polyolefins can be individually silane grafted and then combined.

In a variation, the silane-grafted polyolefin component includes first silane-grafted polyolefin and a second silane-grafted polyolefin formed from a first base polyolefin and a second base polyolefin, respectively. Therefore, the first silane-grafted polyolefin can be crosslinked to the second silane-grafted polyolefin and to the elastomer component with C-C bonds. Moreover, the second silane-grafted polyolefin can also be crosslinked to the elastomer component with C-C bonds.

In a refinement, the first silane-grafted polyolefin and the second silane-grafted polyolefin are each independently selected from the group consisting of silane-grafted ethylene αolefin copolymers, silane-grafted olefin block copolymers, and combinations thereof.

As set forth above, the reactive mixture includes a peroxide. In a refinement, the peroxide includes a peroxide component selected from the group consisting of hydrogen peroxide, alkyl hydroperoxides, dialkyl peroxides, and diacyl peroxides. Examples for the peroxide include, but are not limited to, an organic peroxide selected from the group consisting of di(tertbutylperoxyisopropyl) benzene, di-t-butyl peroxide, t-butyl cumyl peroxide, dicumyl peroxide, 2,5-dimethyl-2,5-di(t-butyl-peroxy)hexyne-3, 1,3-bis(t-butyl-peroxy-isopropyl)benzene, n-butyl-4,4-bis(t-butyl-peroxy)valerate, benzoyl peroxide, t-butylperoxybenzoate, t-butylperoxy isopropyl carbonate, t-butylperbenzoate, bis(2-methylbenzoyl)peroxide, bis(4-methylbenzoyl)peroxide, t-butyl peroctoate, cumene hydroperoxide, methyl ethyl ketone peroxide, lauryl peroxide, tert-butyl peracetate, di-t-amyl peroxide, t-amyl peroxybenzoate, 1,1-bis(t-butylperoxy)-3,3,5-trimethylcyclohexane, α,α′-bis(t-butylperoxy)-1,3-diisopropylbenzene, α,α′-bis(t-butylpexoxy)-1,4-diisopropylbenzene, 2,5-bis(t-butylperoxy)-2,5-dimethylhexane, 2,5-bis(t-butylperoxy)-2,5-dimethyl-3-hexyne, 2,4-dichlorobenzoyl peroxide, and combinations thereof.

In some aspects, the base polyolefin is a copolymer of an olefin selected from the group consisting of ethylene, propylene, 1-butene, 1-propene, 1-hexene, 1-octene, C₉₋₂₀ olefins, and combinations thereof. Examples of comonomers include but are not limited to aliphatic C₂₋₂₀ αolefins. Examples of suitable aliphatic C₂₋₂₀ α-olefins include ethylene, propylene, 1-butene, 4-methyl-1-pentene, 1-hexene, 1-octene, 1-decene, 1-dodecene, 1-tetradecene, 1-hexadecene, 1- octadecene and 1-eicosene. In a refinement, the comonomer is vinyl acetate. The amount of comonomer can, in some embodiments, be from greater than 0 wt % to about 12 wt % based on the weight of the polyolefin, including from greater than 0 wt % to about 9 wt %, and from greater than 0 wt % to about 7 wt %. In some embodiments, the comonomer content is greater than about 2 mol % of the final polymer, including greater than about 3 mol % and greater than about 6 mol %. The comonomer content may be less than or equal to about 30 mol %. A copolymer can be a random or block (heterophasic) copolymer. In some embodiments, the polyolefin is a random copolymer of propylene and ethylene.

In some aspects, the base polyolefins is selected from the group consisting of an olefin homopolymer, a blend of homopolymers, a copolymer made using two or more olefins, a blend of copolymers each made using two or more olefins, and a combination of olefin homopolymers blended with copolymers made using two or more olefins. The olefin may be selected from ethylene, propylene, 1-butene, 1-propene, 1-hexene, 1-octene, and other higher 1-olefin. In some aspects, the polyethylene used for the at least one polyolefin can be classified into several types including, but not limited to, LDPE (Low Density Polyethylene), LLDPE (Linear Low Density Polyethylene), and HDPE (High Density Polyethylene). In other aspects, the polyethylene can be classified as Ultra High Molecular Weight (UHMW), High Molecular Weight (HMW), Medium Molecular Weight (MMW) and Low Molecular Weight (LMW). In still other aspects, the polyethylene may be an ultra-low density ethylene elastomer.

In a variation, the base polyolefin component is selected from the group consisting of ethylene α-olefin copolymers, polyolefin elastomer (POE), olefin block copolymers, and combinations thereof.

In other refinements, the base polyolefin is selected from the group consisting of olefin homopolymers, blends of homopolymers, copolymers of two or more olefins, blends of copolymers of two or more olefins, and a combination of olefin homopolymers blended with copolymers of two or more olefins.

In another refinement, the base polyolefin includes a polymer selected from the group consisting of block copolymers, ethylene propylene diene monomer polymers, ethylene octene copolymers, ethylene butene copolymers, ethylene α-olefin copolymers, 1-butene polymer with ethene, polypropylene homopolymers, silane-grafted methacrylate-butadiene-styrene polymers, silane-grafted polymers with isotactic propylene units with random ethylene distribution, styrenic block copolymers, styrene ethylene butylene styrene copolymer, and combinations thereof.

The one or more base polyolefins can be a polyolefin elastomer including an olefin block copolymer, an ethylene α-olefin copolymer, a propylene α-olefin copolymer, isotactic propylene units with random ethylene distributions, polyolefin elastomer/ethylene-octene copolymer, styrene ethylene butylene styrene copolymer, EPDM, EPM, or a mixture of two or more of any of these materials. Specific examples for the base polyolefins are as follows. Exemplary olefin block copolymers include those sold under the trade names INFUSE™ (e.g., INFUSE 9530, INFUSE 9817, INFUSE 9900, AND INFUSE 9107) commercially available from (the Dow Chemical Company) and SEPTON™ V-SERIES (e.g., SEPTON V 9641), a styrene-ethylene-butylene-styrene block copolymer available from Kuraray Co., LTD. An example of a styrene ethylene butylene styrene copolymer (SEBS) is TUFTEC P 1083 (Asahi Kase). Exemplary ethylene α-olefin copolymers include those sold under the trade names TAFMER™ (e.g., TAFMER DF710 and TAFMER DF 605) (Mitsui Chemicals, Inc.), and ENGAGE™ (e.g., ENGAGE 8150) (the Dow Chemical Company). Exemplary propylene α-olefin copolymers include those sold under the trade name VISTAMAXX™ 6102 grades (Exxon Mobil Chemical Company), TAFMER™ XM (Mitsui Chemical Company), and VERSIFY™ (Dow Chemical Company). An example of isotactic propylene units with random ethylene distributions VISTAMAXX 8880 (Exxon Mobil Chemical Company). An ethylene based polymer/polyolefin elastomer is Tafmer K8505S (Mitsui Chemicals, Inc.). Exemplary ethylene-octene copolymers include Engage 8677 and Engage 8407 (the Dow Chemical Company), FORTIFY C11075DF and FORTIFY C05075DF (Sabic), SOLUMER 871L and SOLUMER 8705L (SK Global Chemical). An example of a polyolefin elastomer/ethylene-octene copolymer is ENGAGE 8401. Examples of ethylene butene are Engage 7467/7457/7447/7367/7270/7256 (the Dow Chemical Company). An exemplary, 1-butene polymer with ethene is LC 165 LG Chemical. An exemplary, polypropylene Homopolymer is MOSTEN NB 425 (Unipetrol RPA). An exemplary, methacrylate-butadiene-styrene (MBS) is PARALOID EXL 3691(the Dow Chemical Company).

As set forth above, the masterbatch (i.e., component B) can include ethylene vinyl acetate copolymers. It should be appreciated that the masterbatch can also include any of the polymers listed for the base polyolefin set forth below.

In a refinement, component A includes one or more olefin block copolymer in an amount from about 50 to 96 weight percent of the total weight of component A. In another refinement, component A includes an olefin block copolymer and ethylene octene copolymer each independently in an amount from about 30 to 70 weight percent of the total weight of component A. In another refinement, component A includes an olefin block copolymer mixture and ethylene octene copolymer each independently in an amount from about 30 to 70 weight percent of the total weight of component A. In another refinement, component A includes an olefin block copolymer and Styrene ethylene butylene styrene copolymer each independently in an amount from about 30 to 70 weight percent of the total weight of component A.

In some aspects, the at least one polyolefin may have a molecular weight distribution Mw/Mn of less than or equal to about 5, less than or equal to about 4, from about 1 to about 3.5, or from about 1 to about 3.

The base polyolefin may be present in an amount of from greater than 0 wt % to about 100 wt % of the composition. In some embodiments, the amount of polyolefin elastomer is from about 30 wt % to about 70 wt %. In some aspects, the at least one polyolefin fed to an extruder can include from about 50 wt % to about 80 wt % of an ethylene alpha-olefin copolymer, including from about 60 wt % to about 75 wt % and from about 62 wt % to about 72 wt %.

The at least one base polyolefin can have a melt index measured at 190° C. under a 2.16 kg load, of from about 20.0 g/10 min to about 3,500 g/10 min, including from about 250 g/10 min to about 1,900 g/10 min and from about 300 g/10 min to about 1,500 g/10 min. In some aspects, the at least one polyolefin has a fractional melt index of from 0.5 g/10 min to about 3,500 g/10 min.

In some aspects, the density of the at least one base polyolefin is less than about 0.90 g/cm³, less than about 0.89 g/cm³, less than about 0.88 g/cm³, less than about 0.87 g/cm³, less than about 0.86 g/cm³, less than about 0.85 g/cm³, less than about 0.84 g/cm³, less than about 0.83 g/cm³, less than about 0.82 g/cm³, less than about 0.81 g/cm³, or less than about 0.80 g/cm³. In other aspects, the density of the at least one polyolefin may be from about 0.85 g/cm³ to about 0.89 g/cm³, from about 0.85 g/cm³ to about 0.88 g/cm3, from about 0.84 g/cm³ to about 0.88 g/cm³, or from about 0.83 g/cm³ to about 0.87 g/cm³. In still other aspects, the density is at about 0.84 g/cm³, about 0.85 g/cm³, about 0.86 g/cm³, about 0.87 g/cm³, about 0.88 g/cm³, or about 0.89 g/cm³.

The percent crystallinity of the base polyolefin may be less than about 60%, less than about 50%, less than about 40%, less than about 35%, less than about 30%, less than about 25%, or less than about 20%. The percent crystallinity may be at least about 10%. In some aspects, the crystallinity is in the range of from about 2% to about 60%.

Table 1 provides an example of a general recipe for Component A and Component B.

TABLE 1

Exemplary compositions for components A and B

| | | |
|---|---|---|
| | Ingredient | Content in the Component (weight percent) |
| Component A (wt%) | Grafted POE mixture | 100.0 |
| Component B (phr) | Ethylene vinyl acetate copolymer | 20.0 to 50.0 or 30.0 to 40.0 |
| | Ethylene based α-olefin elastomer | 0.0 to 50.0 or 1 to 50 |
| | Ethylene Propylene Diene Terpolymer | 0.0 to 50.0 or 1 to 50 |
| | Silicon Rubber | 0.0 to 15.0 or 1 to 15.0 |
| | Zinc oxide | 0 to 10 or 1 to 8.0 |
| | Stearic acid | 0 to 10 or 1 to 4.0 |
| | Silane-modified amorphous poly-alpha-olefins | 0.0 to 20.0 or 1 to 20.0 |
| | trans-Polyoctenamer-Rubber (TOR) | 0.0 to 20.0 or 1 to 20.0 |
| | Silica/ Silicon oxide | 0.0 to 30.0 or 1 to 30.0 |
| | Titanium oxide | 0.0 to 25.0 or 1 to 25.0 |
| | Organic pigment, Red | 0.000 to 0.375 or 0.010 to 0.375 |
| | Organic pigment, Blue | 0.0 to 1.5 or 0.1 to 1.5 |
| | Di(tert-butylperoxyisopropyl) benzene | 0 to 10 or 5.0 to7.0 |
| | Triallyl cyanurate (FARIDA TACE) | 0.0.5 to 0.5 or 0.1 to 0.4 |
| | Modified Azodicarbonamide | 0.0 to 12.0 or 1.0 to 7.0 |
| | Azodicarbonamide | 0.0 to 16.0 or 1.0 to 7.0 |

In another embodiment, a masterbatch (i.e., component B) for forming a midsole is provided. The masterbatch includes at least one elastomer. Typically, the masterbatch also includes a blowing agent, stearic acid, an optional activator, optional additives, and a peroxide. Examples of the optional additives includes, silicon rubber, zinc oxide, silane-modified amorphous poly-alpha-olefins, trans-polyoctenamer-rubber (TOR), silica/ silicon oxide, titanium oxide, organic pigments, (e.g., red organic pigment, blue organic pigment), triallyl cyanurate, and combinations thereof. In a refinement, the additives includes activators, accelerators, and crosslinking agents. Zinc oxide is an example of an activator. Triallyl cyanurate can be characterized as a co-agent, crosslinking agent, accelerator, or an activator. As set forth above, the elastomer component includes a polymer selected from the group consisting of ethylene vinyl acetate copolymers, polyolefin elastomers, anhydride-modified ethylene copolymers, and combinations thereof. The masterbatch is adapted to be combined (e.g., mixed) with component A as set forth above to form a reactive mixture. In this context, adapted to be combined means that the masterbatch is in pellet or powder form suitable for combining with Component A. As set forth herein, Component A includes a mixture of a first silane-grafted polyolefin and a second silane-grafted polyolefin (and optionally, one or more additional silane-grafted polyolefins). The reactive mixture is reacted for a predetermined time period under moisture-free conditions at a reaction temperature to form a foamed peroxide-crosslinked polyolefin elastomer such that the first silane-grafted polyolefin is crosslinked to the second silane-grafted polyolefin and to the elastomer component with C-C bonds and the second silane-grafted polyolefin is crosslinked to the elastomer component with C-C bonds. In other words, the silane-grafted polyolefin component is crosslinked to the elastomer component with C-C bonds. The reactive mixture is also reacted such that the foamed peroxide-crosslinked polyolefin elastomer includes a plurality of closed cells. The predetermined time period and the reaction temperature will depend on the specific compositions for Component A and the masterbatch. Typically, the predetermined time period is from about 200 to 600 seconds, and the reaction temperature is from about 160 to 200° C. In some variations, the reactive mixture is reacted in a reactive extrusion reactor. Details for the components of the masterbatch, the method of using the masterbatch, and properties of midsoles formed therefrom are the same a set forth above and in the examples described below.

The following examples illustrate the various embodiments of the present invention. Those skilled in the art will recognize many variations that are within the spirit of the present invention and scope of the claims.

### Foamed Peroxide-Crosslinked Polyolefin Elastomer Samples

Foamed peroxide-crosslinked polyolefin elastomer samples were formed by the methods set forth above. Tables 2 provides compositions in weight percentages for forming Component A which includes a silane-grafted polyolefin elastomer. Tables 3-1. 3-2, 3-3, and 3-4 provides compositions in phr for forming Component B. The compositions of Tables 3-1, 3-2, 3-3, 3-4, and 4 are used to prepare Examples 1-3 set forth below. Table 4 summarizes some of the tests used to characterize the foamed peroxide-crosslinked polyolefin elastomer.

TABLE 2

Component A formulations

| Ingredient (wt%) | A-1 | A-2 |
|---|---|---|
| Ethylene-octene copolymer #1 | 28.50 | 28.50 |
| Ethylene-octene copolymer #2 | | 70.00 |
| Ethylene α-olefin copolymer | 70.00 | |
| Silane cocktail | 1.50 | 1.50 |

TABLE 3-1

Component B formulation.

| Ingredient (phr) | B-1 |
|---|---|
| Ethylene vinyl acetate copolymer (EVA) grade # 1 | 30.0 |
| Ethylene vinyl acetate (EVA) copolymer (40%wt vinyl acetate content) | 20.0 |
| Ethylene α-olefin copolymer #1 | 50.0 |
| ZnO | 2.0 |
| Stearic acid | 1.0 |
| Di(tert-butylperoxyisopropyl) benzene | 5.0 |
| Triallyl cyanurate (FARIDA TACE)) | 0.10 |
| Modified Azodicarbonamide #1 | 12.0 |

TABLE 3-2

Component B formulations.

| Ingredient (phr) | B-2 | B-3 | B-4 |
|---|---|---|---|
| Ethylene vinyl acetate copolymer (EVA) grade # 1 | 30 | 30 | 50 |
| Ethylene vinyl acetate (EVA) copolymer (40%wt vinyl acetate content) | 20 | 20 | - |
| Ethylene α-olefin copolymer #1 | 50 | - | 20 |
| Ethylene based α-olefin elastomer | - | 50 | 30 |
| ZnO | 2 | 2 | 2 |
| Stearic acid | 1 | 1 | 1 |
| 14-40FL | 5.0 | 5.0 | 5.0 |
| Triallyl cyanurate (FARIDA TACE) | 0.1 | 0.1 | 0.1 |
| Modified Azodicarbonamide #1 | 12.0 | 12.0 | 12.0 |

TABLE 3-3

Component B formulations.

| Ingredient (phr) | B-5 |
|---|---|
| Ethylene vinyl acetate copolymer (EVA) grade # 1 | 15 |
| Ethylene α-olefin copolymer #1 | 85 |
| Silicon rubber | 10 |
| ZnO | 2 |
| Stearic acid | 1 |
| Di(tert-butylperoxyisopropyl) benzene | 5.0 |
| Triallyl cyanurate (FARIDA TACE) | 0.1 |
| Modified Azodicarbonamide #1 | 12.0 |

TABLE 3-4

Component B formulation.

| Ingredient (phr) | B-6 |
|---|---|
| Ethylene vinyl acetate copolymer (EVA) grade #1 | 50 |
| Ethylene based α-olefin elastomer | 50 |
| ZnO | 2 |
| Stearic acid | 1 |
| Di(tert-butylperoxyisopropyl) benzene | 5.0 |
| Triallyl cyanurate (FARIDA TACE) | 0.1 |
| Modified Azodicarbonamide #1 | 12.0 |
| Modified Azodicarbonamide #2 | 12.0 |

TABLE 4

Test methods used to characterize foamed peroxide-crosslinked polyolefin elastomer samples.

| # | Test | Unit | Standard |
|---|---|---|---|
| 1 | Specific Gravity -Density | None -gr/cc | ASTM D 297/ ASTM 1505 |
| 2 | Hardness | Shore C | ASTM D 2240 |
| 3 | Split tear | kg_{f}/cm | ASTM D 3574 |
| 4 | Tensile | kg_{f}/cm² | ASTM D 3574 |
| 5 | Elongation | % | ASTM D 3574 |
| 6 | Tear | kg_{f}/cm | ASTM D 624 |
| 7 | Resilience (Ball) | % | ASTM D 3574 |
| 8 | Water Absorption | % | ASTM D1056 |
| 9 | Compression set | % | No ASTM Standard (Cond. 50° C./6 hr; 50% compression) |

The compression set can be determined as follows: samples are compressed 50% of their thickness at 50° C. for 6 hr between two parallel plates (a fixture). Then the samples are removed from fixture, and new thickness is measured (after 30 min in RT) and the C/set is reported in percentage. Sample size Diameter: 25.4 mm/ thickness: 10 mm.

Foamed peroxide-crosslinked polyolefin elastomer samples can be prepared by dry blending or mixing the various components set forth in Tables 2, 3-1. 3-2, 3-3, and 3-4 together. An injection molding process (a compression molding system) was used to form Examples 1, 2, and 3 from a Component A formulation of Table 2 and a Component B formulation of Tables 3-1. 3-2, 3-3, or 3-4. Compositions, molding temperatures, times as well as properties of the foamed peroxide-crosslinked polyolefin elastomer samples are summarized in Tables 5 to 7. Table 8 is an EVA control example. The composition and properties of the EVA control sample are summarized in Table 9.

TABLE 5

Example 1

| | | | |
|---|---|---|---|
| A-1 (wt%) | 66.7 | | |
| B-1 (wt%) | 28.5 | | |
| Modified azodicarbonamide (wt%) | 4.8 | | |
| Molding temp. (°C) | 180 | | |
| Molding time (sec) | 340 | | |
| Mold thickness (mm) | 7 | 10 | 12.5 |

Properties

| | | | |
|---|---|---|---|
| Size (W/L/T, mm) | 195/259/11.0 | 174/280/17.2 | 185/291/25.1 |
| ER (%) | 166 | 168 | 169 |
| Sp. Gr. | 0.169 | 0.153 | 0.148 |
| Hd (C type) | 34 | 33 | 33 |
| Split (kg/cm) | 1.2 | 1.3 | 1.3 |
| C/set (%) | 50 | 55 | 57 |
| Tensile (kg/cm²) | 17.9 | 17.3 | 17.1 |
| Elongation (%) | 289 | 352 | 345 |
| Tear (kg/cm) | 8.0 | 8.2 | 8.5 |
| Resilience (%) | 75 | 75 | 75 |
| Remark | Two side skin on | One side skin on | One sided skin on |

TABLE 6

| Ingredient | Example 2 | | | |
|---|---|---|---|---|
| A-1 (wt%) | 69.3 | 67.9 | 66.7 | 62.5 |
| B-1 (wt%) | 29.7 | 29.1 | 28.5 | 26.7 |
| Modified azodicarbonamide (wt%) | 1 | 3 | 4.8 | 10.8 |
| Mold thickness (mm) | 12.5 | | | 10 |
| Molding temp. (°C) | 180 | | | |
| Molding time (s) | 600 | 340 | 340 | 400 |
| Properties | | | | |
| ER(%) | 143 | - | - | - |
| Specific Gravity | 0248 | 0.198 | 0.146 | 0.102 |
| Hd (C type) | 45 | 38 | 31 | 23 |
| Split tear (kg/cm) | 2.1 | 1.65 | 1.25 | 0.8 |
| C/set (%) | 46/45 | 47/48 | 58/56 | 68/66 |
| Tensile (kg/cm²) | 23.1/24.3 | 19.5/21.3 | 15.9/16.5 | 15.1/14.5 |
| Elongation (%) | 203/216 | 258/264 | 262/305 | 242/245 |
| Tear (kg/cm) | 12.8/12.5 | 11.4/11.9 | 7.3/7.7 | 6.7/6.2 |
| Resilience (%) | 74 | 74 | 75 | 78 |

TABLE 7

| Ingredient | Example 3 | |
|---|---|---|
| A-1 (wt%) | 67.9 | |
| B-5 (wt%) | 29.1 | |
| Modified azodicarbonamide (wt%) | 3 | |
| Molding condition | 180° C. X 340 sec | |
| Mold thickness (mm) | 12.5 | |
| Specific Gravity | 0.194 | 0.202 |
| Hd (C type) | 36 | 37 |
| Split tear (kg/cm) | 1.85 | 1.9 |
| C/set (%) | 45.1/46.5 | 44.0/44.1 |
| Tensile (kg/cm²) | 17.8/18.3 | 18.4/15.4 |
| Elongation (%) | 341/381 | 329/257 |
| Tear (kg/cm) | 11.9/10.5 | 10.5/10.4 |
| Resilience (%) | 76 | 77 |

TABLE 8

EVA control example

| Ethylene vinyl acetate copolymer (EVA) grade #3 (wt%) | 87 | | |
|---|---|---|---|
| ZnO (wt%) | 1.8 | | |
| Stearic acid (wt%) | 0.8 | | |
| TiO₂ (wt%) | 4.3 | | |
| Di(tert-butylperoxyisopropyl) benzene (wt%) | 1.8 | | |
| Modified azodicarbonamide (wt%) | 4.3 | | |
| Molding temp. (°C) | 170 | | |
| Molding time (sec) | 420 | | |
| Mold thickness (mm) | 7 | 10 | 12.5 |
| Properties | | | |
| Size (W/L/T, mm) | 200/265/11.7 | 179/289/17.3 | 188/295/25.7 |
| ER (%) | 170 | 171 | 172 |
| Sp. Gr. | 0.156 | 0.150 | 0.143 |
| Hd (C type) | 41 | 40 | 40 |
| Split tear (kg/cm) | 1.3 | 1.5 | 1.5 |
| Tensile strength (kg/cm²) | 21.1 | 20.1 | 20.0 |
| Elongation (%) | 220 | 232 | 202 |
| Tear (kg/cm) | 8.4 | 9.3 | 9.4 |
| C/set (%) | 43 | 53 | 54 |
| Resilience (%) | 60 | 60 | 60 |
| Remark | Two side skin on | One side skin on | One side skin on |

### Properties Description

### 1. Compression Load/Deflection

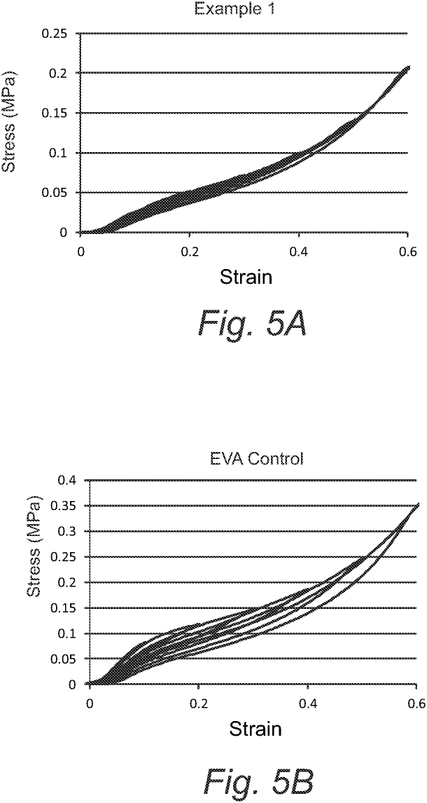

Compression load/deflection measurements were performed using an Instron 5965 with a load cell having a 100 N capacity. The compression platen was 50 mm diameter flat steel plate pressing against platform shimmed to less than 50 micron level by feeler gauge. The sample sizes were 16 mm diameter, and the test speed was100 mm/min. A custom procedure using a 6-step cyclical compression at 10, 20, 30, 40, 50, and 60% compression (6 cycles) was used. FIGS. 5A to 5E provide plots of stress versus strain for examples 1 and the EVA control.

TABLE 9

Energy loss from compression load/deflection measurements

| Sample | Example 1 | EVA Control |
|---|---|---|
| Energy loss (J) | 0.01 | 0.11 |

### 2. Gel Test

Gel tests were performed as follows. An initial sample weight measurement (W₁) was determined. The samples were submerged in boiling xylene for 5 hours (~139° C.) and then subjected to 2 hours of heated vacuum drying at 150° C. (vacuum ~ 25 inches of mercury vacuum pressure). If this drying was insufficient, the samples are placed in a vacuum oven for 48 hr (at 150° C.). After air cooling for about 72 hours, the sample weight (W₂) was determined. The % Gel is determined as about W₁/W₂. Results for the gel test are presented below in Table 10. The high gel percentages are indicative of higher amounts of cross linking since sample with significant crosslinking.

TABLE 10

Gel content

| Sample | Example 1 | EVA Control |
|---|---|---|
| Gel% | 72 | 77 |

### 3. Differential Scanning Calorimetry (DSC)

DSC was used to determine Tg, Tm, Tc, and % crystallinity. TA Discovery DSC 250 instrument with a Tzero pan and Tzero lid was used for the analysis. Samples having a weight of about 5-10 mg were cut by razor blade from the plaque. Samples were first heated from room temperature (ramp 20° C./min) to 200° C. and cooled to -88° C. A second heating to 200° C. (ramp 10° C./min) was performed. A N₂ gas 50 ml/min purge was used. The percent (%) crystallinity was determined from the following equations using the information form the second heat cycle:

$$\% \text{Crystallinity =} \left[Δ H m / Δ H m \left(100 \%\right)\right] * 100$$

ΔHₘ(100%) for LDPE = 293 J/g

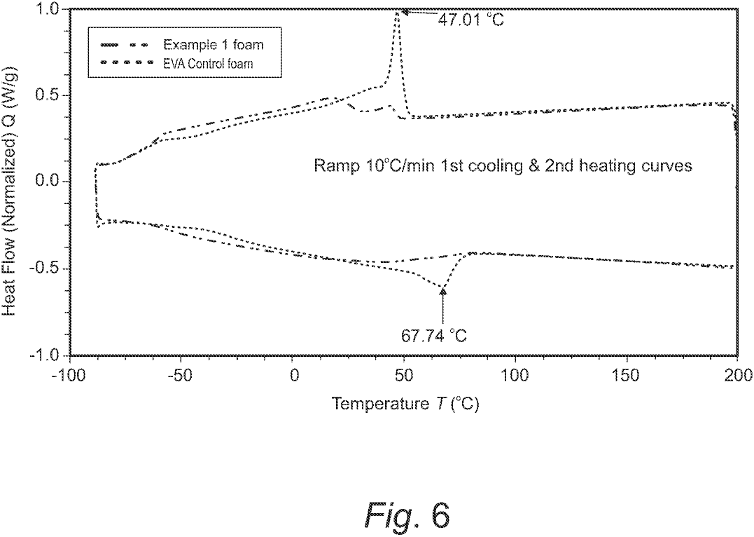

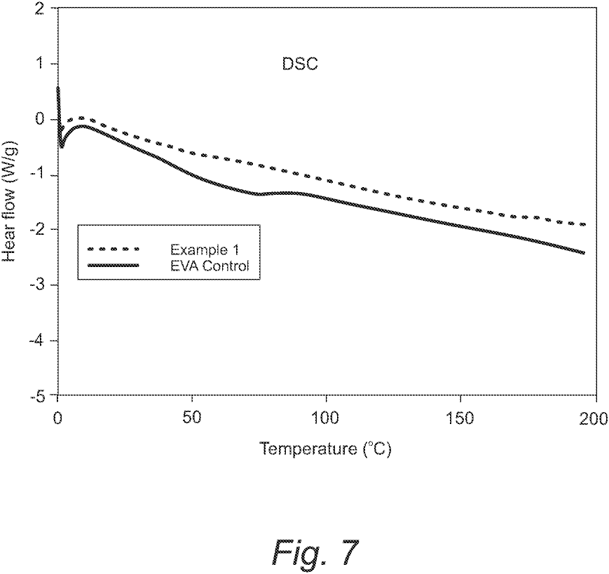

DSC plots are provided in FIGS. 6 and 7 with the results summarized in Table 11.

TABLE 11

DSC properties.

| Foam Sample | Tg (°C) | Tₘ(°C) | ΔHm (J/g) | Crystallinity (%) | Tc (°C) |
|---|---|---|---|---|---|
| Example 1 | -56.4 | 43.9 | 12.3 | 4.2 | 44.0 |
| EVA Control | -28.5 | 67.7 | 26.5 | 9.0 | 47.0 |

The determined melting points (Tₘ) were between 40 and 120° C. As set forth above, melting point is a significant parameter in controlling shrinkage of the foamed peroxide-crosslinked polyolefin elastomer and/or the shoe midsole. The combination of the melting points with the high resilience determined by the shear rheometer of FIG. 4 that the samples can achieve low shrinkage and higher resilience.

### 4. Dynamic Mechanical Analyzer Measurements

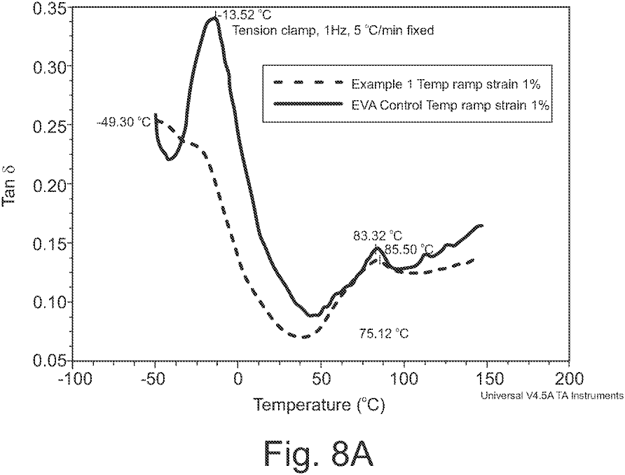

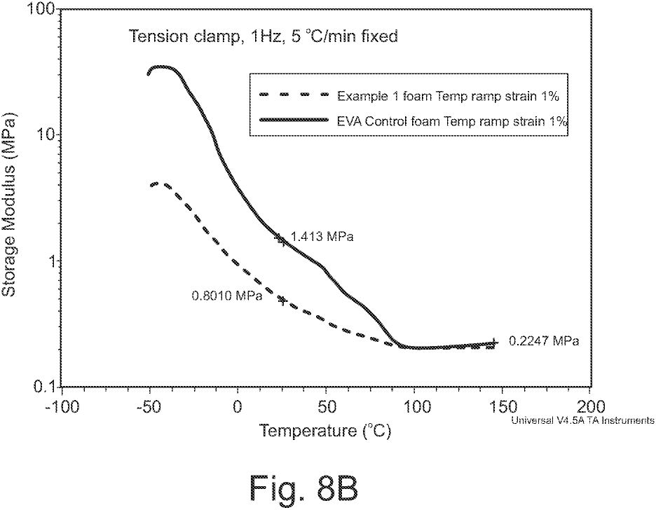

DMA temp ramp testing was performed as follows. A DMA-Q800 was used for the DMA measurements with clamp-tension and Mode- DMA multi frequency strain. A temp ramp 5° C./min - 50° C. to 150° C. with strain 1 % and frequency 1 Hz. Foamed samples were cut to specimen dimension (Length 10.0 ± 0.5 mm, Width ~3.5 mm, Thickness ~3.0 mm). FIGS. 8A and 8B provide the results of the DMA experiments. FIG. 8A is a plot of Tan δ versus temperature while FIG. 8B is a plot of storage modulus versus temperature for example 1 and the EVA control example.

TABLE 12

Tan δ values.

| Foam Sample | Tan δ at 30° C. |
|---|---|
| Example 1 | 0.0732 |
| EVA control | 0.1091 |

It should be appreciated that higher values of Tan δ indicates that the material absorbs more energy. For midsole application, lower Tan δ values are desirable indicating that the material is more resilient.

### 5. Rheology

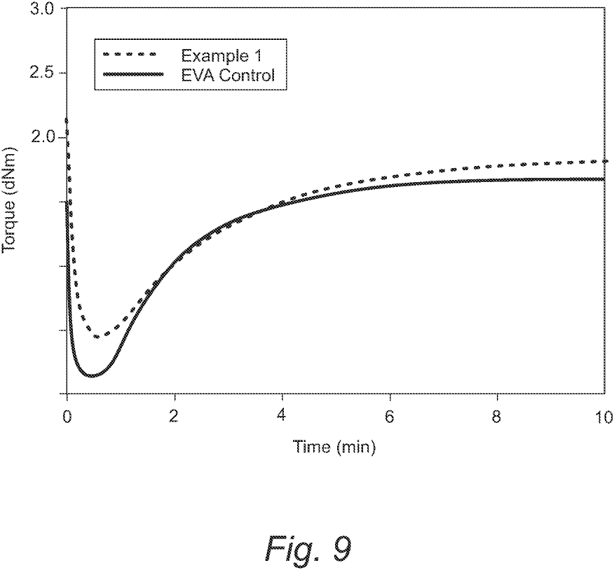

FIG. 9 provides plots from a shear rheometer using a rotational cylinder comparing a POE with silane grafting and without silane grafting. These plots give the cure rates for example 1 and the EVA control.

### 6. Long-Chain Branching (LCB) Index

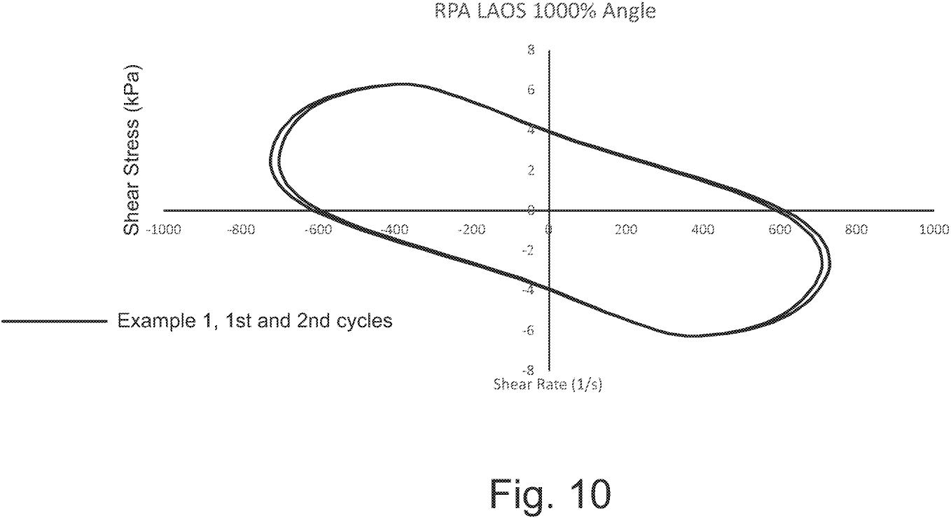

A Rubber Process Analyzer (RPA was used to determine the amount of long-chain branching. FIG. 10 provides plots of shear stress versus shear rate. Table 13 provides values of the branching index for example 1.

TABLE 13

Branching index.
Example 1

| | | |
|---|---|---|
| LCB Index | 19.87 | 20.58 |

From these experiments, it is objection that the amount of branching increases as the amount of silane increases.

### 7. Water Absorption

Water absorption for the samples was determined in accordance with ASTM D1056. Table 14 provides the results of the water absorption experiments. In general, the samples are weighted and then soaked in water. The samples are then reweighted to determine the amount of absorbed water. It is observed that moisture does not significantly enter into the foam. Walter the prior art uses a polymer that they claim will let the moisture to get in. Crosslinks produced through the condensation chemistry require moisture for the crosslinking. The present invention relies on peroxide crosslinks through the use of silane grafted polymer that is free of moisture during the process and after the product is formed.

TABLE 14

Water absorption.

| Sample | Sample Dimension (L, W, H, mm) | Water absorption (%) |
|---|---|---|
| Example 1 | 174/280/17.2 | 0.10 |
| | 50.8/50.8/11.0 | 0.09 |
| EVA Control | 179/289/17.3 | 0.27 |
| | 50.8/50.8/11.0 | 0.25 |

### 8. Scanning Electron Microcopy.

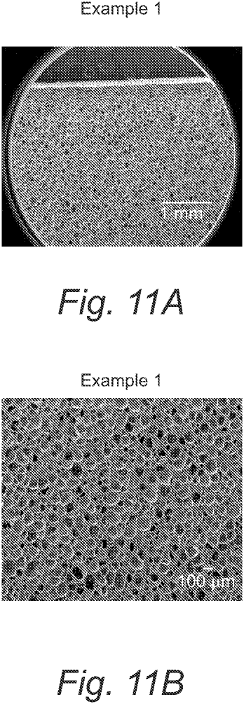

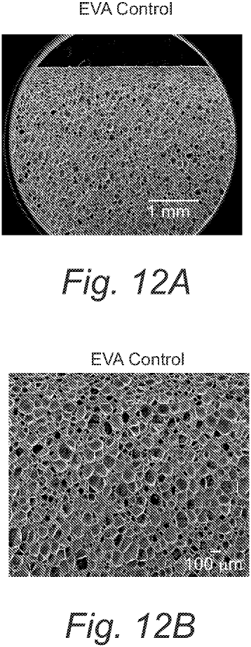

FIGS. 11 to 12 provides scanning electron micrographs for samples 1 to 5 at 25x and 50x. The micrographs show a connected network of closed cells which provides excellent water absorption resistance. The closed cells are pores having diameters from about 10 microns to about 300 microns.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A shoe midsole composed of a foamed peroxide-crosslinked polyolefin elastomer comprising:
a silane-grafted polyolefin component; and
an elastomer component including an elastomer selected from the group consisting of ethylene vinyl acetate copolymer, polyolefin elastomers, anhydride modified ethylene copolymers, and combinations thereof, the silane-grafted polyolefin component and elastomer component being crosslinked with C-C bonds, wherein the foamed peroxide-crosslinked polyolefin elastomer includes a plurality of closed cells, the foamed peroxide-crosslinked polyolefin elastomer being substantially free of silane crosslinking as formed and substantially free of water.

2. The shoe midsole of claim 1 wherein the foamed peroxide-crosslinked polyolefin elastomer has a shape configured to be place in a shoe above an outsole.

3. The shoe midsole of claim 1 wherein the shoe midsole exhibits a compression set of from about 1.0% to about 67.0%, as measured after 6 hours being tested at 50° C.

4. The shoe midsole of claim 1 wherein the plurality of closed cells includes a connected network of closed cells.

5. The shoe midsole of claim 1 wherein the silane-grafted polyolefin component includes a first silane-grafted polyolefin and a second silane-grafted polyolefin.

6. The shoe midsole of claim 5 wherein the first silane-grafted polyolefin and the second silane-grafted polyolefin each independent includes internal C-C crosslinking.

7. The shoe midsole of claim 5 wherein the first silane-grafted polyolefin and the second silane-grafted polyolefin are each independently selected from the group consisting of silane-grafted ethylene α-olefin copolymers, silane-grafted olefin block copolymers, and combinations thereof.

8. The shoe midsole of claim 5 wherein the first silane-grafted polyolefin and the second silane-grafted polyolefin each independently include silane functional groups grafted thereon having formula I: 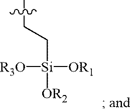
R
₁, R₂, and R₃ are each independently H or C₁₋₈ alkyl.

9. The shoe midsole of claim 8 wherein R₁, R₂, and R₃ are each methyl, ethyl, propyl, or butyl.

10. The shoe midsole of claim 5 wherein the first silane-grafted polyolefin has a first melt index less than about 5 and the second silane-grafted polyolefin has a second melt index greater than about 20.

11. The shoe midsole of claim 5 wherein the first silane-grafted polyolefin is selected from the group consisting of silane-grafted olefin homopolymers, blends of silane-grafted homopolymers, silane-grafted copolymers of two or more olefins, blends of silane-grafted copolymers of two or more olefins, and a combination of silane-grafted olefin homopolymers blended with silane-grafted copolymers of two or more olefins.

12. The shoe midsole of claim 5 wherein the first silane-grafted polyolefin and the second silane-grafted polyolefin are each independently a silane-grafted copolymer of an olefin selected from the group consisting of ethylene, propylene, 1-butene, 1-propene, 1-hexene, 1-octene, C₉₋₁₆ olefins, and combinations thereof.

13. The shoe midsole of claim 5 wherein the second silane-grafted polyolefin is selected from the group consisting of silane-grafted olefin homopolymers, blends of silane-grafted homopolymers, silane-grafted copolymer of two or more olefins, blends of silane-grafted copolymers of two or more olefins, and blends of silane-grafted olefin homopolymers with silane-grafted copolymers of two or more olefins.

14. The shoe midsole of claim 5 wherein the second silane-grafted polyolefin is a silane grafted homopolymer or copolymer of an olefin is selected from the group consisting of ethylene, propylene, 1-butene, 1-propene, 1-hexene, 1-octene, and C₉₋₁₆ olefins.

15. The shoe midsole of claim 5 wherein the first silane-grafted polyolefin and the second silane-grafted polyolefin independently include a polymer selected from the group consisting of silane-grafted block copolymers, silane-grafted ethylene propylene diene monomer polymers, silane-grafted ethylene octene copolymers, silane-grafted ethylene butene copolymers, silane-grafted ethylene α-olefin copolymers, silane-grafted 1-butene polymer with ethene, silane-grafted polypropylene homopolymers, silane-grafted methacrylate-butadiene-styrene polymers, silane-grafted polymers with isotactic propylene units with random ethylene distribution, silane-grafted styrenic block copolymers, silane-grafted styrene ethylene butylene styrene copolymer, and combinations thereof.

16. The shoe midsole of claim 5 wherein the first silane-grafted polyolefin has a density less than 0.86 g/cm³ and the second silane-grafted polyolefin has a crystallinity less than 40%.

17. The shoe midsole of claim 5, wherein the first silane-grafted polyolefin is present in an amount from about 60 to 80 weight percent of the total weight of the shoe midsole.

18. The shoe midsole of claim 17, wherein the second silane-grafted polyolefin is present in an amount from about 20 to 40 weight percent of the total weight of the shoe midsole.

19. The shoe midsole of claim 5, wherein the first silane-grafted polyolefin has a higher weight average molecular weight that the second silane-grafted polyolefin.

20. The shoe midsole of claim 1 wherein the elastomer component includes ethylene vinyl acetate copolymer.

21. The shoe midsole of claim 20 wherein the ethylene vinyl acetate copolymer has a vinyl acetate content from about 10 to 50 mole percent.

22. The shoe midsole of claim 1 wherein the elastomer component includes a copolymer of an olefin selected from the group consisting of ethylene, propylene, 1-butene, 1-propene, 1-hexene, 1-octene, C₉₋₁₆ olefins, and combinations thereof.

23. The shoe midsole of claim 1 wherein the elastomer component includes a polymer selected from the group consisting of block copolymers, ethylene propylene diene monomer polymers, ethylene octene copolymers, ethylene butene copolymers, ethylene α-olefin copolymers, 1-butene polymer with ethene, polypropylene homopolymers, methacrylate-butadiene-styrene polymers, polymers with isotactic propylene units with random ethylene distribution, styrenic block copolymers, styrene ethylene butylene styrene copolymer, and combinations thereof.

24. The shoe midsole of claim 1 substantially free of a condensation catalyst or a residue thereof.

25. The shoe midsole of claim 1 including an additive selected from the group consisting of stearic acid, zinc oxide, titanium oxide, silicon oxide, and combinations thereof.

26. The shoe midsole of claim 1 including one or more residues of a blowing agent, cross linkers, and addition promotors.

27. The shoe midsole of claim 1, wherein having a rebound resilience of at least 60%.

28. The shoe midsole of claim 1, wherein having a melting temperature of greater than 40° C.

29. A method for preparing a shoe midsole, the method comprising:
forming a component A including a mixture of a first silane-grafted polyolefin and a second silane-grafted polyolefin;
forming a masterbatch (component) including a blowing agent, a peroxide, additives, and an an elastomer selected from the group consisting of ethylene vinyl acetate copolymer, polyolefin elastomers, anhydride modified ethylene copolymers, and combinations thereof; and
mixing component A and component B to form a reactive mixture; and
reacting the reactive mixture for a predetermined time period under moisture-free conditions at a reaction temperature to form a foamed peroxide-crosslinked polyolefin elastomer such that the first silane-grafted polyolefin is crosslinked to the second silane-grafted polyolefin and to the elastomer component with C-C bonds and the second silane-grafted polyolefin is crosslinked to the elastomer component with C-C bonds and such that the foamed peroxide-crosslinked polyolefin elastomer includes a plurality of closed cells, the foamed peroxide-crosslinked polyolefin elastomer being substantially free of silane crosslinking as formed and substantially free of water.

30. The method of claim 29 wherein the foamed peroxide-crosslinked polyolefin elastomer is molded with a shape configured to be placed in a shoe above an outsole.

31. The method of claim 29 wherein the predetermined time period is from about 200 to 450 seconds and the reaction temperature is from about 160 to200° C.

32. The method of claim 29 wherein the peroxide includes a peroxide component selected from the group consisting of hydrogen peroxide, alkyl hydroperoxides, dialkyl peroxides, and diacyl peroxides.

33. The method of claim 29 wherein the peroxide includes an organic peroxide selected from the group consisting of di-t-butyl peroxide, t-butyl cumyl peroxide, dicumyl peroxide, 2,5-dimethyl-2,5-di(t-butyl-peroxy)hexyne-3, 1,3-bis(t-butyl-peroxy-isopropyl)benzene, n-butyl-4,4-bis(t-butyl-peroxy)valerate, benzoyl peroxide, t-butylperoxybenzoate, t-butylperoxy isopropyl carbonate, t-butylperbenzoate, bis(2-methylbenzoyl)peroxide, bis(4-methylbenzoyl)peroxide, t-butyl peroctoate, cumene hydroperoxide, methyl ethyl ketone peroxide, lauryl peroxide, tert-butyl peracetate, di-t-amyl peroxide, t-amyl peroxybenzoate, 1,1-bis(t-butylperoxy)-3,3,5-trimethylcyclohexane, α,α′-bis(t-butylperoxy)-1,3-diisopropylbenzene, α,α′-bis(t-butylpexoxy)-1,4-diisopropylbenzene, 2,5-bis(t-butylperoxy)-2,5-dimethylhexane, and 2,5-bis(t-butylperoxy)-2,5-dimethyl-3-hexyne and 2,4-dichlorobenzoyl peroxide.

34. The method of claim 29 wherein the first silane-grafted polyolefin and the second silane-grafted polyolefin are each independent formed by silane grafting a base polyolefin.

35. The method of claim 34 wherein the base polyolefin is a copolymer of an olefin selected from the group consisting of ethylene, propylene, 1-butene, 1-propene, 1-hexene, 1-octene, C₉₋₁₆ olefins, and combinations thereof.

36. The method of claim 29 wherein the reactive mixture is reacted in an injection molding apparatus.

37. The method of claim 29 wherein the first silane-grafted polyolefin and the second silane-grafted polyolefin are each independently selected from the group consisting of silane-grafted ethylene α-olefin copolymers, silane-grafted olefin block copolymers, and combinations thereof.

38. The method of claim 29 wherein component B includes an ethylene vinyl acetate copolymer.

39. The method of claim 29 wherein component B includes a copolymer of an olefin selected from the group consisting of ethylene, propylene, 1-butene, 1-propene, 1-hexene, 1-octene, C₉₋₁₆ olefins, and combinations thereof.

40. The method of claim 29 wherein the elastomer component includes a polymer selected from the group consisting of block copolymers, ethylene propylene diene monomer polymers, ethylene octene copolymers, ethylene butene copolymers, ethylene α-olefin copolymers, 1-butene polymer with ethene, polypropylene homopolymers, methacrylate-butadiene-styrene polymers, polymers with isotactic propylene units with random ethylene distribution, styrenic block copolymers, styrene ethylene butylene styrene copolymer, and combinations thereof.

41. A masterbatch for forming a midsole, the masterbatch comprising:
a blowing agent;
a peroxide;
additives; and
an elastomer selected from the group consisting of ethylene vinyl acetate copolymers, polyolefin elastomers, anhydride-modified ethylene copolymers, and combinations thereof, the masterbatch being adapted to be combined with a Component A under moisture-free conditions to form a reactive mixture, the Component A including a mixture of a first silane-grafted polyolefin and a second silane-grafted polyolefin and optionally one or more additional silane-grafted polyolefins, wherein the reactive mixture is reacted for a predetermined time period under moisture-free conditions at a reaction temperature to form a foamed peroxide-crosslinked polyolefin elastomer such that such that the first silane-grafted polyolefin is crosslinked to the second silane-grafted polyolefin and to the elastomer component with C-C bonds and the second silane-grafted polyolefin is crosslinked to the elastomer component with C-C bonds and such that the foamed peroxide-crosslinked polyolefin elastomer includes a plurality of closed cells, the foamed peroxide-crosslinked polyolefin elastomer being substantially free of silane crosslinking as formed and substantially free of water.

42. The masterbatch of claim 41 wherein the foamed peroxide-crosslinked polyolefin elastomer is molded with a shape configured to be placed in a shoe above an outsole.

43. The masterbatch of claim 41 wherein the predetermined time period is from about 200 to 600 seconds and the reaction temperature is from about 160 to 200° C.

44. The masterbatch of claim 41 wherein the peroxide includes a peroxide component selected from the group consisting of hydrogen peroxide, alkyl hydroperoxides, dialkyl peroxides, and diacyl peroxides.

45. The masterbatch of claim 41 wherein the peroxide includes an organic peroxide selected from the group consisting of di-t-butyl peroxide, t-butyl cumyl peroxide, dicumyl peroxide, 2,5-dimethyl-2,5-di(t-butyl-peroxy)hexyne-3, 1,3-bis(t-butyl-peroxy-isopropyl)benzene, n-butyl-4,4-bis(t-butyl-peroxy)valerate, benzoyl peroxide, t-butylperoxybenzoate, t-butylperoxy isopropyl carbonate, t-butylperbenzoate, bis(2-methylbenzoyl)peroxide, bis(4-methylbenzoyl)peroxide, t-butyl peroctoate, cumene hydroperoxide, methyl ethyl ketone peroxide, lauryl peroxide, tert-butyl peracetate, di-t-amyl peroxide, t-amyl peroxybenzoate, 1,1-bis(t-butylperoxy)-3,3,5-trimethylcyclohexane, α,α′-bis(t-butylperoxy)-1,3-diisopropylbenzene, α,α′-bis(t-butylpexoxy)-1,4-diisopropylbenzene, 2,5-bis(t-butylperoxy)-2,5-dimethylhexane, and 2,5-bis(t-butylperoxy)-2,5-dimethyl-3-hexyne and 2,4-dichlorobenzoyl peroxide.

46. The masterbatch of claim 41 wherein the first silane-grafted polyolefin and the second silane-grafted polyolefin are each independent formed by silane grafting a base polyolefin.

47. The masterbatch of claim 46 wherein the base polyolefin is a copolymer of an olefin selected from the group consisting of ethylene, propylene, 1-butene, 1-propene, 1-hexene, 1-octene, C₉₋₁₆ olefins, and combinations thereof.

48. The masterbatch of claim 41 wherein the first silane-grafted polyolefin and the second silane-grafted polyolefin are each independently selected from the group consisting of silane-grafted ethylene α-olefin copolymers, silane-grafted olefin block copolymers, and combinations thereof.

49. The masterbatch of claim 41 wherein component B includes an ethylene vinyl acetate copolymer.

50. The masterbatch of claim 41 wherein component B includes a copolymer of an olefin selected from the group consisting of ethylene, propylene, 1-butene, 1-propene, 1-hexene, 1-octene, C₉₋₁₆ olefins, and combinations thereof.

51. The masterbatch of claim 41 wherein the elastomer component includes a polymer selected from the group consisting of block copolymers, ethylene propylene diene monomer polymers, ethylene octene copolymers, ethylene butene copolymers, ethylene α-olefin copolymers, 1-butene polymer with ethene, polypropylene homopolymers, methacrylate-butadiene-styrene polymers, polymers with isotactic propylene units with random ethylene distribution, styrenic block copolymers, styrene ethylene butylene styrene copolymer, and combinations thereof.
